(19) United States
(12) Patent Application Publication
(10) Pub. No.: US 2021/0396908 A1
(43) Pub. Date: Dec. 23, 2021

(54) Intelligent Weather Data Service

(71) Applicant: LOON LLC, Mountain View, CA (US)

(72) Inventor: Salvatore J. Candido, Mountain View, CA (US)

(73) Assignee: LOON LLC, Mountain View, CA (US)

(21) Appl. No.: 16/905,767

(22) Filed: Jun. 18, 2020

(51) Int. Cl. G01W 1/10; G01W 1/18

(52) U.S. Cl. CPC G01W 1/10; G01W 2001/006; G01W 1/18

(57) ABSTRACT

The technology relates to an intelligent weather data service for providing optimized weather forecast data using real time weather observation data in response to weather forecast requests. A weather data system may include a scorer job configured to obtain weather observation data and weather forecast data from a plurality of weather data sources and to generate a plurality of error scores for the weather forecast data over a predetermined time period, each of the plurality of error scores corresponding to one of the plurality of weather data sources and indicating, for a cell on a grid map, an amount or a probability of error in the weather forecast data by a weather data source in relation to the weather observation data; an observations index configured to index the weather observation data; a data store configured to store the plurality of error scores; and a fusion layer configured to receive and respond to a weather data request using the plurality of error scores.

### BACKGROUND OF INVENTION

Operational weather forecasting agencies generate forecasts using one or more numerical weather forecast models. At any given time, there are a number of forecasts available to use, including National Oceanic and Atmospheric Administration's (NOAA's) Global Forecast System (GFS) or the European Center for Medium-Range Weather Forecast's (ECMWF's) high resolution forecasts (HRES). In addition, some agencies produce ensemble forecasts, such as ECMWF's ensemble prediction system (ENS), which comprise a set of forecasts run slightly differently (i.e., slight variation of its initial conditions and with slightly perturbed weather models) to produce a probabilistic forecast (i.e., a range of future weather possibilities). Each of these weather forecast data sources have their strengths and weaknesses in terms of accuracy in certain situations (e.g., types of weather, locations, times, climates), and for any given time and location, some forecasts will perform better than others.

Traditionally meteorologists manually select or blend forecasts from different sources to generate bespoke forecasts for specific situations, but many use cases can benefit from a service that can analyze forecast data from multiple sources against observed weather data in real time (i.e., directly after source data is updated or directly after observation data is updated), and provide optimized weather forecasts for desired locales and/or situations by selecting more accurate, or blending combinations of, weather forecast data for such locales and situations based on data and statistical models, rather than human intuition and knowledge.

Thus, there is a need for an intelligent weather data service capable of providing optimized weather forecast data using real time weather observation data in response to varying weather forecast requests.

### BRIEF SUMMARY

The present disclosure provides for techniques relating to an intelligent weather data service for providing optimized weather forecast data using real time weather observation data in response to weather forecast requests. A weather data system may include a scorer job configured to obtain weather observation data and weather forecast data from a plurality of weather data sources and to generate a plurality of error scores for the weather forecast data over a predetermined time period, each of the plurality of error scores corresponding to one of the plurality of weather data sources and indicating, for a cell on a grid map, an amount or a probability of error in the weather forecast data by a weather data source in relation to the weather observation data; an observations index configured to index the weather observation data; a data store configured to store the plurality of error scores; and a fusion layer configured to receive and respond to a weather data request using the plurality of error scores.

In some examples, the weather observation data is indexed by the observations index according to the grid map. In some examples, the grid map represents a region of interest and is divided into a plurality of cells. In some examples, the plurality of cells comprise S2 cells. In some examples, the region of interest is the Earth. In some examples, the plurality of weather data sources comprises an output of a numerical weather forecast model. In some examples, the plurality of weather data sources comprises an ensemble output from an ensemble model.

A method for evaluating accuracy of weather forecasts includes obtaining, by a scorer job, weather forecast data from two or more weather data sources; obtaining, by the scorer job, weather observation data for one or more cells on a grid map from an observations index; generating a plurality of error scores, the plurality of error scores comprising an error score for each of the weather data sources for each of the one or more cells, each of the plurality of error scores representing an average error over a predetermined time period; storing the plurality of error scores in a data store; and generating an updated plurality of error scores.

In some examples, the one or more cells corresponds to a location of interest. In some examples, generating the plurality of error scores includes determining a root mean square error (RMSE) for each of the one or more cells between each of the two or more weather data sources and corresponding weather observation data. In some examples, generating the plurality of error scores includes determining a centered root mean square error (CRMSE) for each of the one or more cells between each of the two or more weather data sources and corresponding weather observation data. In some examples, generating the updated plurality of error scores includes updating an error score for each of the plurality of error scores in an order of the one or more cells using a most recent update of each of the two or more weather data sources. In some examples, generating the updated plurality of error scores includes updating an error score for a cell when a new weather observation for the cell is available from the observations index. In some examples, generating the updated plurality of error scores includes updating an error score for a cell when an update from at least one of the two or more weather data sources becomes available. In some examples, the predetermined time period comprises an amount of time it takes to generate the plurality of error scores for the one or more cells on the grid map.

A method for providing intelligent weather data service includes obtaining, by a fusion layer, a plurality of error scores for a predetermined time period, the plurality of error scores comprising an error score for a cell on a grid map and for each of two or more weather data sources; receiving a weather data request; selecting weather forecast data from one or more of the two or more weather data sources to include in a response to the weather data request, the weather forecast data selected based on error scores corresponding to the two or more weather data sources; and generating the response to the weather data request, the response comprising desired weather forecast data based on the weather forecast data that was selected.

In some examples, selecting weather forecast data is based on a lowest error score for a location or a region indicated in the weather data request, the location or the region being represented by the cell on the grid map. In some examples, selecting weather forecast data is based on a lowest error score for a time period indicated in the weather data request. In some examples, selecting weather forecast data is based on a lowest error score for a time of day indicated in the weather data request. In some examples, selecting weather forecast data is based on a lowest error score for a season indicated in the weather data request. In some examples, selecting weather forecast data comprises determining a weighted average of the error scores corresponding to the two or more weather data sources. In some examples, selecting weather forecast data comprises generating an ensemble.

### BRIEF DESCRIPTION OF THE DRAWINGS

FIG. 1 is a simplified block diagram of an intelligent weather data service, in accordance with one or more embodiments;

FIG. 2 is a flow diagram illustrating a method for evaluating accuracy of a weather forecast, in accordance with one or more embodiments;

FIG. 3 is a flow diagram illustrating a method for providing intelligent weather data service, in accordance with one or more embodiments;

FIG. 4A-4B are simplified block diagrams of an exemplary computing system and distributed computing system, respectively, that can be used to implement an intelligent weather data service, in accordance with one or more embodiments;

FIG. 5 is a map diagram illustrating an exemplary use case for requesting weather data from an intelligent weather data service, in accordance with one or more embodiments;

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for dispatching fleets of aircraft by a fleet management and flight planning system. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air vehicles (e.g., floating stratospheric balloons, other floating or wind-driven vehicles), powered lighter than air (LTA) vehicles (e.g., balloons and airships with some propulsion capabilities), fixed-wing vehicles (e.g., drones, rigid kites, gliders), various types of satellites, rockets, space stations, and other high altitude aerial vehicles.

The invention is directed to an intelligent weather data service. Weather forecast data may be obtained from various weather data sources, each weather data source having different strengths (e.g., because of differences in approach, or different ensemble runs. The system includes a scorer job, a model score data store, an observations index, and a fusion layer. The scorer job is a process configured to query weather forecast data from multiple weather data sources (e.g., NOAA's GFS, ECMWF's HRES, ECMWF's ENS, and other ensembles), as well as weather observations (e.g., organized in an index or other database structure), and calculate an average error according to a model (e.g., based on root mean square error (RMSE), centered root mean square error (CRMSE), or other similar error metric) during a preceding period of time (e.g., N hours). An observations index may be configured to provide access to said weather observations for one or more geographic regions (e.g., Earth or parts thereof). In some examples, the one or more geographic regions are divided into cells (e.g., s2 cells on a grid of Earth), and weather observations are indexed for each cell in the observations index. The scorer job may generate error scores for each of the weather data sources (e.g. output of a numerical weather forecast model such as GFS or HRES, an ensemble of an ensemble model run such as ECMWF's ENS, and the like) for each cell for a given preceding period of time and store it in a model score data store, each error score corresponding to a cell and a weather data source. For example, an error score may indicate an amount or a probability of error in the weather forecast data by a weather data source in relation to the weather observation data for a cell. In another example, an error score may indicate a baseline a priori estimate of typical error and quality of each source. In some examples, the scorer job also may perform other statistical post-processing of the weather forecast data. In other examples, a post-processed model may be an alternative source of weather data (e.g., post-processing of the weather forecast data occurs separate from scorer job). In some examples, the model score data store may store the error scores by cell (e.g., corresponding to cells in the observations index).

The fusion layer may be configured to receive a request for weather data (e.g., from one or more clients) and to respond to said request by selecting or combining forecast data from the weather data sources according to the error scores generated by the scorer job and stored in the model score data store. Such requests may be for the most accurate weather data for one or more of a given location or region. In some examples, a request may further include criteria such as time of day, season, or other time frame. The fusion layer also may be configured to return the most accurate data given how well observations (i.e., actual “real life” weather data) match with a forecast (e.g., to date, during a selected time period, or other time frame). In an example, the fusion layer may select a forecast with the lowest error score. In another example, the fusion layer may select a weighted average of forecasts with weights constructed based on error scores associated with the forecast data. In still other examples, the fusion layer may generate other reasonable combinations of the forecast data using the error scores (e.g., other ensembles). In other examples, other factors (e.g., which model tends to be better, overall or at a particular time or location, a priori expectations for a given parameter in a time period or season, a given time of day, or other reasonable bucketing (i.e., aspect, view or categorization)) may be considered with, or used in the absence of, any observations in a given region or location. In returning forecast data to a client, the fusion layer may obtain the forecast data directly from the weather data source(s).

Each weather data source may publish updates at different time intervals. The scorer job may update the error score for each cell in a number of ways: (a) round robin style cell-by-cell using the most recent update to each forecast from each weather data source that is available at the time of update for that cell, (b) asynchronously (e.g., Pub/Sub, wherein the weather data sources are Publishers and the scorer job is a Subscriber), (c) ad hoc (e.g., updating a cell whenever a new observation is provided for that cell), and (d) other cadence (e.g., a predetermined time period, after a threshold number of weather data sources have published weather forecast updates since the last error score update).

### Example System

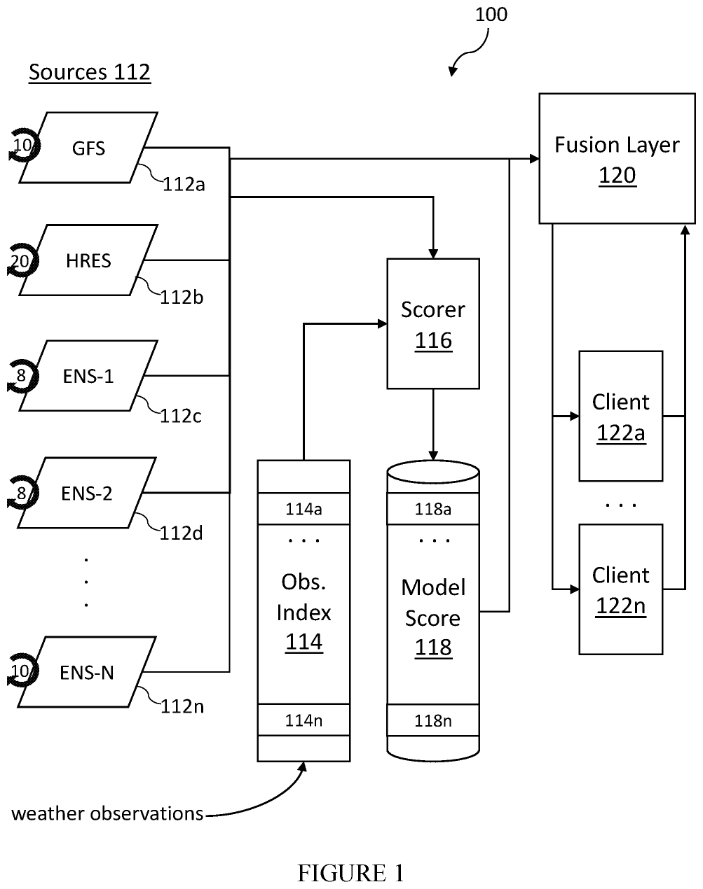

FIG. 1 is a simplified block diagram of an intelligent weather data service, in accordance with one or more embodiments. Diagram 100 shows sources 112, an observations index 114, scorer job 116, model score data store 118, fusion layer 120 and clients 122a-n. Sources 112 may include sources 112a-n. In some examples, sources 112a-n may include an output (e.g., numerical) and/or an ensemble of one, some, or all, of NOAA's GFS, ECMWF's HRES, and various ensembles (e.g., ENS-1-ENS-N). Observations index 114 may be configured to provide access to weather observations (e.g., real time sensor data, or observations data derived from real time sensor data, obtained from weather stations around the world, from a fleet of aerial vehicles equipped with weather-related sensors (e.g., temperature, air pressure, wind speed, and other sensors), and other structures and vehicles equipped with weather-related sensors) for one or more geographic regions (e.g., Earth or parts thereof)). In some examples, observations index 114 also may be configured to index weather observations for a plurality of cells, each cell representing a geographical location (e.g., s2 cells on a grid of Earth). In an example, observations index 114 may comprise weather observations 114a-n, one for each cell in a region of interest, Earth globally, or other part thereof.

Scorer job 116 may be configured to query weather forecast data from sources 112 and weather observations from observations index 114. Scorer job 116 further may be configured to calculate an average error for each cell represented in observations index 114, and for each of sources 112, according to an analytical model (e.g., based on root mean square error (RMSE), centered root mean square error (CRMSE), or other similar error metric). Scorer job 116 may calculate the average error based on said weather forecast data and a corresponding weather observation. Scorer job 116 may generate error scores for each of sources 112 based on an analysis of an output of a numerical weather forecast model or an ensemble of an ensemble model run (e.g., against weather observations 114a-n according to an analytical model), for each cell for a given preceding period of time. Scorer job 116 may be configured to store said error scores (e.g., error scores 118a-n) in model score data store 118. In some examples, error scores 118a-n may be correspondingly stored according to cells representing geographical locations. For example, weather observation 114a may correspond to the same cell as error score 118a, and weather observation 114n may correspond to the same cell as error score 118n. In some examples, each of error scores 118a-n may comprise an individual error score for each of sources 112.

In some examples, each of sources 112a-n may have a refresh or update rate, which may be the same or different than another of sources 112a-n. In an example, as shown, GFS and ENS-N both refresh at the same rate (e.g., every 10 minutes or 10 hours), ENS-1 and ENS-2 refresh at the same rate (e.g., every 8 minutes or 8 hours), and HRES refreshes at its own different rate (e.g., every 20 minutes or 20 hours). In another examples, all sources 112 may be refresh at a same rate, or even standardized to refresh at the same (i.e., synchronously). In yet another example, each of sources 112 may refresh at different times.

Scorer job 116 may update error scores 118a-n in a number of ways: (a) round robin style cell-by-cell in an order (e.g., from weather observation 114a through weather observation 114n) using the most recent update of each forecast or ensemble from sources 112 available at the time of update for that cell, (b) asynchronously, (c) ad hoc (e.g., updating the error score for a cell whenever a new observation is available from observations index 114 for that cell), and (d) other cadences (e.g., a predetermined time period, after a threshold number of sources 112 have published updates since the last error score update).

Fusion layer 120 may be configured to receive a request for weather data from one or more of clients 122a-n, and to respond to said request by selecting or combining forecast data from one or more of sources 112 according to error scores 118a-n, as generated by scorer job 116 and stored in model score data store 118. Such requests may be for accurate weather data for a given location or region, a given time period or season, a given time of day, or other parameter or combination of parameters. Fusion layer 120 may be configured to return accurate weather data based on how well observations (i.e., actual “real life” weather data) match with a forecast (e.g., to date, during a selected time period, or other time frame). In an example, the fusion layer may select a forecast with the lowest error score for the requested location, region, time period, time of day, season, or combination thereof. In another example, the fusion layer may select a weighted average of the forecast data. In still other examples, the fusion layer may generate other reasonable combinations of the forecast data using the error scores (e.g., ensembles). In other examples, other factors (e.g., which model tends to be better, overall or at a particular time or location) may be considered with, or in the absence of, any observations in a requested region or for a requested location (e.g., cell). In returning forecast data to a client, the fusion layer may obtain the forecast data directly from the selected one(s) of sources 112.

### Example Methods

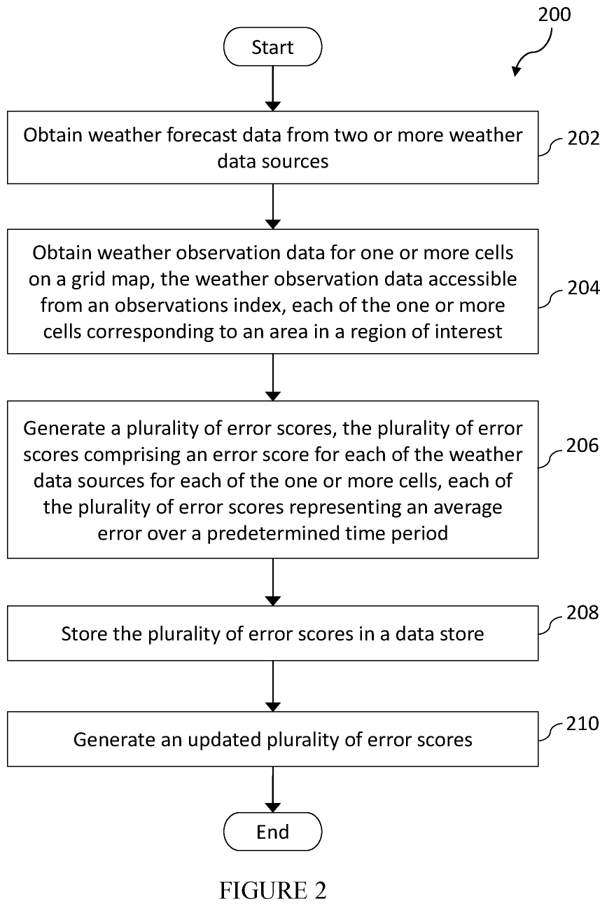

FIG. 2 is a flow diagram illustrating a method for evaluating accuracy of a weather forecast, in accordance with one or more embodiments. Method 200 may begin with obtaining weather forecast data from two or more weather data sources at step 202. As described herein, a scorer job may query weather forecast data from the two or more weather data sources. Each weather data source may comprise output from a numerical weather model or an ensemble from an ensemble run. As described herein, the two or more weather data sources my include one, some, or all, of NOAA's GFS, ECMWF's HRES, and various ensembles (e.g., ENS-1-ENS-N), as shown in FIG. 1. Weather observation data may be obtained for one or more cells on a grid map from an observations index (e.g., observations index 114 in FIG. 1) by the scorer job at step 204. Each of the one or more cells may correspond to a 2D portion of a 2D grid map or 3D portion of a 3D grid map. The grid map may represent Earth or portion thereof, and some or all of the one or more cells may represent a region or location of interest. For example, the one or more cells may represent an area comprising a launch site for launching, or a service area or other target location for flying, aerial vehicles, such as HAPs, HALE aircraft, UAVs, floating stratospheric balloons, other floating or wind-driving vehicles, balloons and airships with some propulsion capabilities, drones, rigid kites, gliders, various types of satellites, rockets, space stations, and other high altitude aerial vehicles. A plurality of error scores may be generated by a scorer job (e.g., scorer job 116 in FIG. 1) at step 206, the plurality of error scores comprising an error score for each of the weather data sources for each of the one or more cells, each of the plurality of error scores representing an average error over a predetermined time period (e.g., a number of preceding hours). In some examples, generating the plurality of error scores may comprise determining a root mean square error (RMSE) for each of the one or more cells, the error score representing an amount or degree of error for each of the two or more weather data sources in view of corresponding weather observation data. In some examples, generating the plurality of error scores may comprise determining a centered root mean square error (CRMSE) for each of the one or more cells, the error score representing an amount or degree of error for each of the two or more weather data sources in view of corresponding weather observation data. The plurality of error scores may be stored in a data store (e.g., model score data score 118) at step 208. In some examples, the plurality of error scores may be stored in a data store in a manner corresponding to cells (e.g., as may be represented in an observations index).

An updated plurality of error scores may be generated at step 210. In some examples, generating the updated plurality of error scores may occur for each of the plurality of error scores in an order of the one or more cells using a most recent update of each of the two or more weather data sources. In some examples, generating the updated plurality of error scores may occur ad hoc, for example, a cell may be updated when a new weather observation for the cell is made available by the observations index. In some examples, generating the updated plurality of error scores may occur for some or all of the one or more cells when an update from at least one of the two or more weather data sources becomes available.

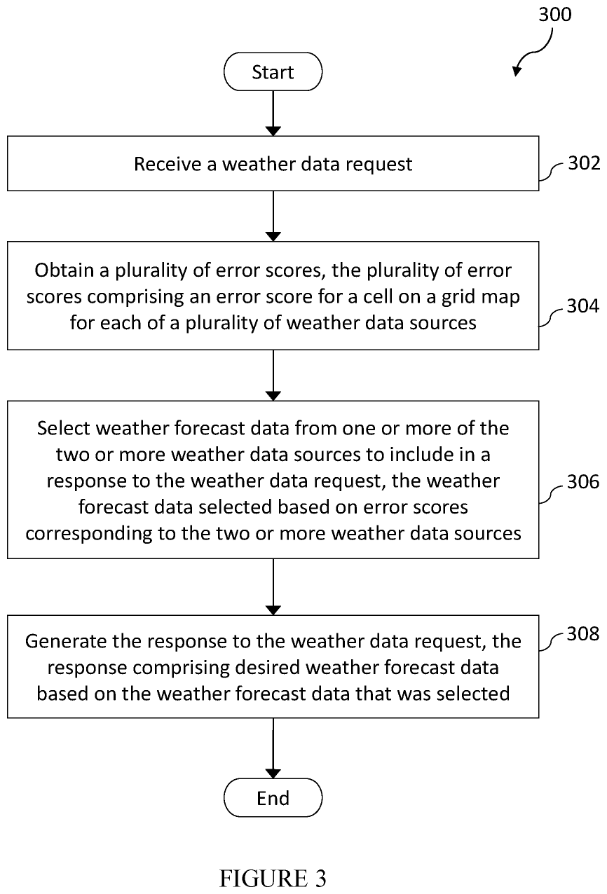

FIG. 3 is a flow diagram illustrating a method for providing intelligent weather data service, in accordance with one or more embodiments. Method 300 may begin with receiving a weather data request at step 302. A plurality of error scores may be obtained at step 302, the plurality of error scores comprising an error score for a cell on a grid map for each of two or more weather data sources. The plurality of error scores may be obtained by a fusion layer, as described herein. Such a fusion layer may obtain error scores for one or more cells associated with a desired region or location indicated in the weather data request. The fusion layer further may select weather forecast data from one or more of the two or more weather data sources to include in a response to the weather data request at step 306. In some examples, the weather forecast data may be selected based on error scores corresponding to the two or more weather data sources. For example, the weather forecast data may be selected based on a lowest error score for a location or a region indicated in the weather data request, the location or the region being represented by one or more cells on the grid map. In another example, the weather forecast data may be selected based on a lowest error score for a time period indicated in the weather data request. In another example, the weather forecast data may be selected based on a lowest error score for a time of day indicated in the weather data request. In another example, the weather forecast data may be selected based on a lowest error score for a season indicated in the weather data request. In another example, the weather forecast data may be selected based on a lowest error score for a combination of the above-described parameters. In still other examples, the weather forecast data may be selected based on a weighted average of the error scores corresponding to the two or more weather data sources, or by generating an ensemble. At step 308, the response to the weather data request may be generated, the response comprising desired weather forecast data based on the weather forecast data that was selected. In some examples, desired weather forecast data may be weather forecast data requested for a location or region, a time period or various time windows, a season, or any other parameter or combination of parameters, as described herein.

### Example Computing Systems

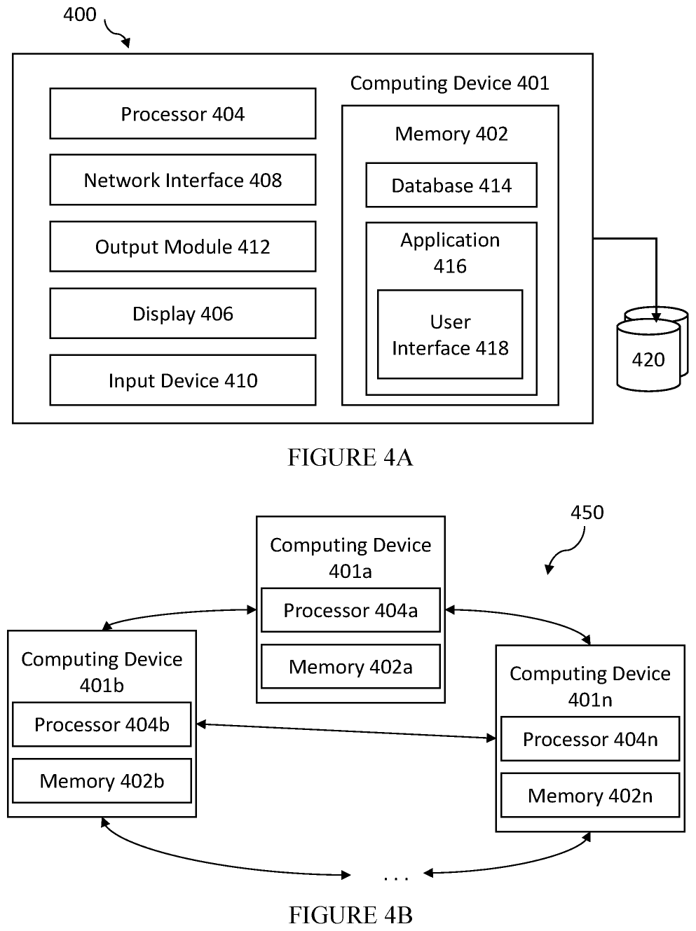

FIG. 4A-4B are simplified block diagrams of an exemplary computing system and distributed computing system, respectively, that can be used to implement an intelligent weather data service, in accordance with one or more embodiments. In one embodiment, computing system 400 may include computing device 401 and storage system 420. Storage system 420 may comprise a plurality of repositories and/or other forms of data storage, and it also may be in communication with computing device 401. In another embodiment, storage system 420, which may comprise a plurality of repositories, may be housed in one or more of computing device 401 (not shown). In some examples, storage system 420 may store state data, commands, indexes, model scores, and other various types of information as described herein. This information may be retrieved or otherwise accessed by one or more computing devices, such as computing device 401 or 401a-n in FIG. 4B, in order to perform some or all of the features described herein. Storage system 420 may comprise any type of computer storage, such as a hard-drive, memory card, ROM, RAM, DVD, CD-ROM, write-capable, and read-only memories. In addition, storage system 420 may include a distributed storage system where data is stored on a plurality of different storage devices, which may be physically located at the same or different geographic locations (e.g., in a distributed computing system such as system 450 in FIG. 4B). Storage system 420 may be networked to computing device 401 directly using wired connections and/or wireless connections. Such network may include various configurations and protocols, including short-range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 401 also may include a memory 402. Memory 402 may comprise a storage system configured to store a database 414 and an application 416. Application 416 may include instructions which, when executed by a processor 404, cause computing device 401 to perform various steps and/or functions, as described herein. Application 416 further includes instructions for generating a user interface 418 (e.g., graphical user interface (GUI)). Database 414 may store various algorithms and/or data, including neural networks (e.g., encoding flight policies or planning algorithms) and data regarding wind patterns, weather forecast data, weather observations, past and present locations of aerial vehicles, sensor data, map information, air traffic information, among other types of data. Memory 402 may include any non-transitory computer-readable storage medium for storing data and/or software that is executable by processor 404, and/or any other medium which may be used to store information that may be accessed by processor 404 to control the operation of computing device 401.

Computing device 401 may further include a display 406, a network interface 408, an input device 410, and/or an output module 412. Display 406 may be any display device by means of which computing device 401 may output and/or display data. Network interface 408 may be configured to connect to a network using any of the wired and wireless short-range communication protocols described above, as well as a cellular data network, a satellite network, free space optical network and/or the Internet. Input device 410 may be a mouse, keyboard, touch screen, voice interface, and/or any or other hand-held controller or device or interface by means of which a user may interact with computing device 401. Output module 412 may be a bus, port, and/or other interface by means of which computing device 401 may connect to and/or output data to other devices and/or peripherals.

In one embodiment, computing device 401 is a datacenter or other control facility (e.g., configured to run a distributed computing system as described herein), and may communicate with a controller and/or flight control system (e.g., to provide desired weather forecast data). As described herein, system 400, and particularly computing device 401, may provide weather forecast data for planning a launch and flight path for an aerial vehicle (e.g., along a desired heading or within a desired radius of a target location), a service location, or other location from which an aerial, terrestrial, or water vehicle may fly, sail, drive, float, or otherwise travel to, through and from. Various configurations of system 400 are envisioned, and various steps and/or functions of the processes described below may be shared among the various devices of system 400 or may be assigned to specific devices.

In FIG. 4B, system 450 may comprise two or more computing devices 401a-n. In some examples, each of 401a-n may comprise one or more of processors 404a-n, respectively, and one or more of memory 402a-n, respectively. Processors 404a-n may function similarly to processor 404 in FIG. 4A, as described above. Memory 402a-n may function similarly to memory 402 in FIG. 4A, as described above. In some examples, one or more of computing devices 401a-n may be a datacenter configured to perform steps in the intelligent weather data service methods described herein. In some examples, computing devices 401a-n may be networked using wired connections and/or wireless connections, as described herein.

### Example Use Cases

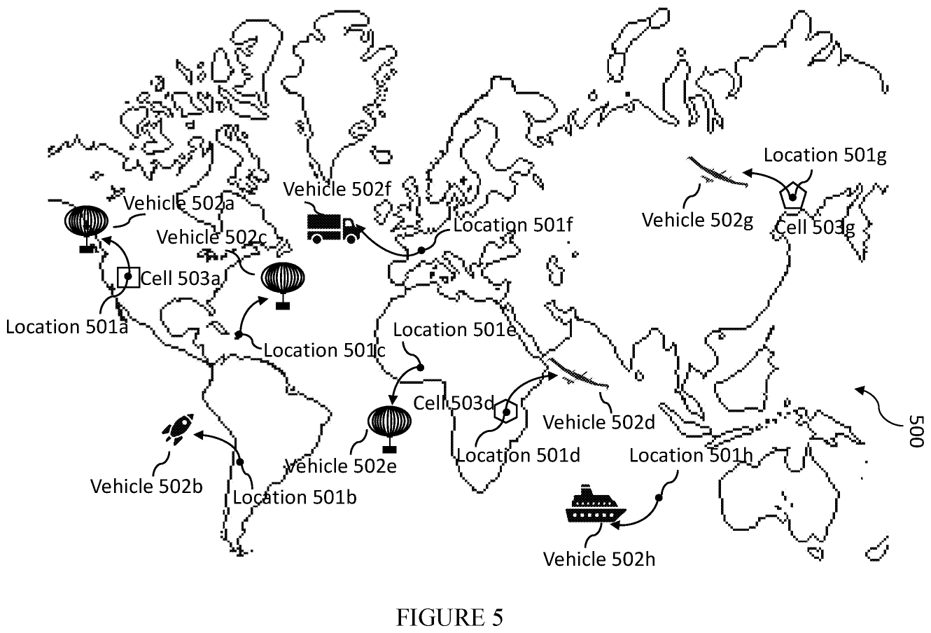

FIG. 5 is a map diagram illustrating an exemplary use case for requesting weather data from an intelligent weather data service, in accordance with one or more embodiments. Map 500 includes locations 501a-h, vehicles 502a-h, and cells 503a, 503d, and 503g. Each of locations 501a-h may represent a launch site, a service location, or other target location, from which an aerial, terrestrial, or water vehicle may be launched, fly, sail, drive, float, or otherwise travel to and from. Diagram 500 also shows vehicles 502a-h, which may be launching, flying, driving, sailing, or floating, at or in locations 501a-h, respectively. Vehicles 502a-h may be any aerial vehicle or aircraft, as described herein (e.g., HAPs, HALE aircraft, UAVs, floating stratospheric balloons, other floating or wind-driving vehicles, balloons and airships with some propulsion capabilities, drones, rigid kites, gliders, various types of satellites, rockets, space stations, and other high altitude aerial vehicles), as well as any terrestrial (e.g., car, truck, sport utility vehicle, and the like) and water vehicle (e.g., boat, ship, submarine). In an example, in planning a launch window for vehicle 502a from location 501a, a client device may request from an intelligent weather data service, as described herein, weather forecast data for one or more desired launch windows (i.e., time periods) for a desired location (e.g., North America, the Western United States of America, cell 503a or a state comprising cell 503a). In some examples, the one or more desired launch windows may include an amount of time for vehicle 502a to reach a float threshold, to exit a layer of the Earth's atmosphere, or reach another threshold altitude. In other examples, such an amount of time may be accounted for separately from the launch window (e.g., as a separate parameter). The intelligent weather data service may obtain weather forecast data from multiple weather data sources for the one or more desired launch windows and the desired location, and provide a response comprising the most accurate weather forecast data for each of the one or more desired launch windows for the desired location. Such accurate weather forecast data may be selected based on error scores determined by the systems and methods described above. In other examples, vehicles 502b and 502f similarly may use the intelligent weather data service to obtain weather forecast data for launch windows for their respective locations 501c and 501f.

In another example, a client device may request accurate weather forecast data for a time period for cell 503d to plan a service flight for vehicle 502d. Various types of services (e.g., providing LTE or other Internet connectivity, making Earth observations, gathering environmental data) for location 501d may be desired for a given time period, and accurate weather forecast data may be helpful to plan the service flight (e.g., select a type of aircraft, determine a flight path).

In some examples, map 500 may comprise a grid map broken up into a plurality of cells (not shown). The plurality of cells may divide map 500 into portions or sections in the shape of cell 503a, 503d and/or 503g.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A weather data system comprising:
a scorer job configured to obtain weather observation data and weather forecast data from a plurality of weather data sources and to generate a plurality of error scores for the weather forecast data over a predetermined time period, each of the plurality of error scores corresponding to one of the plurality of weather data sources and indicating, for a cell on a grid map, an amount or a probability of error in the weather forecast data by a weather data source in relation to the weather observation data;
an observations index configured to index the weather observation data;
a data store configured to store the plurality of error scores, and
a fusion layer configured to receive and respond to a weather data request using the plurality of error scores.

2. The system of claim 1, wherein the weather observation data is indexed by the observations index according to the grid map.

3. The system of claim 1, wherein the grid map represents a region of interest and is divided into a plurality of cells.

4. The system of claim 3, wherein the plurality of cells comprise S2 cells.

5. The system of claim 3, wherein the region of interest is the Earth.

6. The system of claim 1, wherein the plurality of weather data sources comprises an output of a numerical weather forecast model.

7. The system of claim 1, wherein the plurality of weather data sources comprises an ensemble output from an ensemble model.

8. A method for evaluating accuracy of weather forecasts comprising:
obtaining, by a scorer job, weather forecast data from two or more weather data sources;
obtaining, by the scorer job, weather observation data for one or more cells on a grid map from an observations index;
generating a plurality of error scores, the plurality of error scores comprising an error score for each of the weather data sources for each of the one or more cells, each of the plurality of error scores representing an average error over a predetermined time period;
storing the plurality of error scores in a data store; and
generating an updated plurality of error scores.

9. The method of claim 8, wherein the one or more cells corresponds to a location of interest.

10. The method of claim 8, wherein generating the plurality of error scores comprises determining a root mean square error (RMSE) for each of the one or more cells between each of the two or more weather data sources and corresponding weather observation data.

11. The method of claim 8, wherein generating the plurality of error scores comprises determining a centered root mean square error (CRMSE) for each of the one or more cells between each of the two or more weather data sources and corresponding weather observation data.

12. The method of claim 8, wherein generating the updated plurality of error scores comprises updating an error score for each of the plurality of error scores in an order of the one or more cells using a most recent update of each of the two or more weather data sources.

13. The method of claim 8, wherein generating the updated plurality of error scores comprises updating an error score for a cell when a new weather observation for the cell is available from the observations index.

14. The method of claim 8, wherein generating the updated plurality of error scores comprises updating an error score for a cell when an update from at least one of the two or more weather data sources becomes available.

15. The method of claim 8, wherein the predetermined time period comprises an amount of time it takes to generate the plurality of error scores for the one or more cells on the grid map.

16. A method for providing intelligent weather data service comprising:
obtaining, by a fusion layer, a plurality of error scores for a predetermined time period, the plurality of error scores comprising an error score for a cell on a grid map and for each of two or more weather data sources;
receiving a weather data request;
selecting weather forecast data from one or more of the two or more weather data sources to include in a response to the weather data request, the weather forecast data selected based on error scores corresponding to the two or more weather data sources; and
generating the response to the weather data request, the response comprising desired weather forecast data based on the weather forecast data that was selected.

17. The method of claim 16, wherein selecting weather forecast data is based on a lowest error score for a location or a region indicated in the weather data request, the location or the region being represented by the cell on the grid map.

18. The method of claim 16, wherein selecting weather forecast data is based on a lowest error score for a time period indicated in the weather data request.

19. The method of claim 16, wherein selecting weather forecast data is based on a lowest error score for a time of day indicated in the weather data request.

20. The method of claim 16, wherein selecting weather forecast data is based on a lowest error score for a season indicated in the weather data request.

21. The method of claim 16, wherein selecting weather forecast data comprises determining a weighted average of the error scores corresponding to the two or more weather data sources.

22. The method of claim 16, wherein selecting weather forecast data comprises generating an ensemble.
